(19) United States
(12) Patent Application Publication
(10) Pub. No.: US 2026/0330526 A1
(43) Pub. Date: Oct. 22, 2026

(54) SYSTEMS AND METHOD FOR FREQUENCY RECOMMENDATION OF A SUBSCRIPTION ITEM

(71) Applicant: Walmart Apollo, LLC, Bentonville, AR (US)

(72) Inventors: Yijie Cao, Secaucus, NJ (US); Sonal Bathe, Sunnyvale, CA (US); Sinduja Subramaniam, Sunnyvale, CA (US); Evren Korpeoglu, San Jose, CA (US)

(21) Appl. No.: 19/180,834

(22) Filed: Apr. 16, 2025

(51) Int. Cl. G06Q 30/0601

(52) U.S. Cl. CPC G06Q 30/0631; G06Q 30/0641

(57) ABSTRACT

Example implementations relate to systems and methods for recommending a frequency of a subscription item. In an example, a system receives subscription data and transaction data. The system determines, using a feature selector, a plurality of purchase intervals for respective plurality of user-item pairs based on the subscription data and the transaction data. The system trains, using the feature selector, a frequency recommendation model based on the plurality of purchase intervals. The system determines, using a frequency recommendation model, an inter-purchase interval for an item. The system also determines, using a frequency recommender, a recommended frequency value for the item based on the inter-purchase interval. Further, the system also generates an interface that includes the recommended frequency value for the item and transmits the interface to a computing device.

### TECHNICAL FIELD

This application relates generally to frequency recommendation of a subscription item, and more particularly, to frequency recommendation of a subscription item based on multiple features.

### BACKGROUND

E-commerce merchants may provide a subscription to facilitate reoccurring purchases of items. Subscriptions may provide convenience for customers and more sales for merchants. E-commerce merchants may provide static recommendations for an item frequency based on an aggregate common purchase frequency. Static recommendations for an item frequency may cause customers to skip or cancel a subscription of an item.

### BRIEF DESCRIPTION OF THE DRAWINGS

Various examples will be described below with reference to the following figures.

FIG. 1 depicts an example system for recommending a frequency for a subscription item, in accordance with some embodiments.

FIG. 2 depicts an example architecture of a frequency recommendation system, in accordance with some embodiments.

FIG. 3 depicts an example feedback interface of a frequency recommendation system, in accordance with some embodiments.

FIG. 4 depicts an example feedback interface of a frequency recommendation system, in accordance with some embodiments.

FIGS. 5A and 5B depicts a flow diagram for recommending a frequency for a subscription item, in accordance with some embodiments.

FIG. 6 depicts a flow diagram illustrating a method for recommending a frequency for a subscription item, in accordance with some embodiments.

FIG. 7 depicts an example system with a machine-readable medium that includes instructions for recommending a frequency for a subscription item, in accordance with some embodiments.

FIG. 8 depicts an example computer system that implements one or more of the disclosed processes, in accordance with some embodiments.

### DETAILED DESCRIPTION

This description of the example embodiments is intended to be read in connection with the accompanying drawings that are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

In various embodiments, a system including a processor and a non-transitory memory storing instructions, that when executed, cause the processor to perform one or more operations for recommending a frequency of a subscription item. The instructions, when executed, cause the processor to receive subscription data and transaction data. The instructions, when executed, cause the processor to determine, using a feature selector, a plurality of purchase intervals for respective plurality of user-item pairs based on the subscription data and the transaction data. The instructions, when executed, cause the processor to train, using the feature selector, a frequency recommendation model based on the plurality of purchase intervals. The instructions, when executed, cause the processor to determine, using a frequency recommendation model, an inter-purchase interval for an item. The instructions, when executed, cause the processor to determine, using a frequency recommender, a recommended frequency value for the item based on the inter-purchase interval. The instructions, when executed, cause the processor to generate an interface that includes the recommended frequency value for the item. The instructions, when executed, cause the processor to transmit the interface to a computing device.

In various embodiments, a computer-implemented method for recommending a frequency of a subscription item is disclosed. The computer-implemented method includes receiving subscription data and transaction data. The computer-implemented method includes determining a plurality of purchase intervals for respective plurality of user-item pairs based on the subscription data and the transaction data. The computer-implemented method includes training a frequency recommendation model based on the plurality of purchase intervals. The computer-implemented method includes determining an inter-purchase interval for an item based on the frequency recommendation model. The computer-implemented method includes determining a recommended frequency value for the item based on the inter-purchase interval. The computer-implemented method includes generating an interface that includes the recommended frequency value for the item. The computer-implemented method includes transmitting the interface to a computing device.

In various embodiments, a non-transitory computer readable medium having instructions for recommending a frequency of a subscription item is disclosed. The instructions, when executed by at least one processor, cause the at least one device to perform operations including receiving subscription data and transaction data. The instructions, when executed by at least one processor, cause the at least one device to perform operations including determining, using a feature selector, a plurality of purchase intervals for respective plurality of user-item pairs based on the subscription data and the transaction data. The instructions, when executed by at least one processor, cause the at least one device to perform operations including training, using the feature selector, a frequency recommendation model based on the plurality of purchase intervals. The instructions, when executed by at least one processor, cause the at least one device to perform operations including determining, using a frequency recommendation model, an inter-purchase interval for an item. The instructions, when executed by at least one processor, cause the at least one device to perform operations including determining, using a frequency recommender, a recommended frequency value for the item based on the inter-purchase interval. The instructions, when executed by at least one processor, cause the at least one device to perform operations including generating an interface that includes the recommended frequency value for the item. The instructions, when executed by at least one processor, cause the at least one device to perform operations including transmitting the interface to a computing device.

The systems and methods disclosed herein can provide personalized and/or dynamic frequency recommendations to a subscriber for subscription items based on past purchase behavior. In some embodiments, the systems and methods disclosed herein can allow for customers without significant purchase history to leverage signals from other user-item interactions. Advantageously, personalized frequency recommendations can optimize merchant and customer stock, minimize skips or cancellations of subscription items, and allow for long-term user retention and conversion compared to certain conventional static frequency recommendations. The systems and methods disclosed herein can allow for dynamic feedback of frequency recommendations to allow recommendations to adapt to changes in customer behavior and/or purchase frequency over time. The systems and methods disclosed herein can recommend a frequency of a subscription item based on one or more of omnichannel transaction data, customer understanding data, item understanding data, customer preference data, and basket understanding data. In some embodiments, the systems and methods disclosed herein can utilize customer item purchase quantity data, customer preferred item frequency data, subscription cancelation data, and subscription skip data. In some embodiments, the systems and methods disclosed herein can capture customer feedback, such as preferred frequency, cancellation, and skip data, and enhance the feature recommendation model.

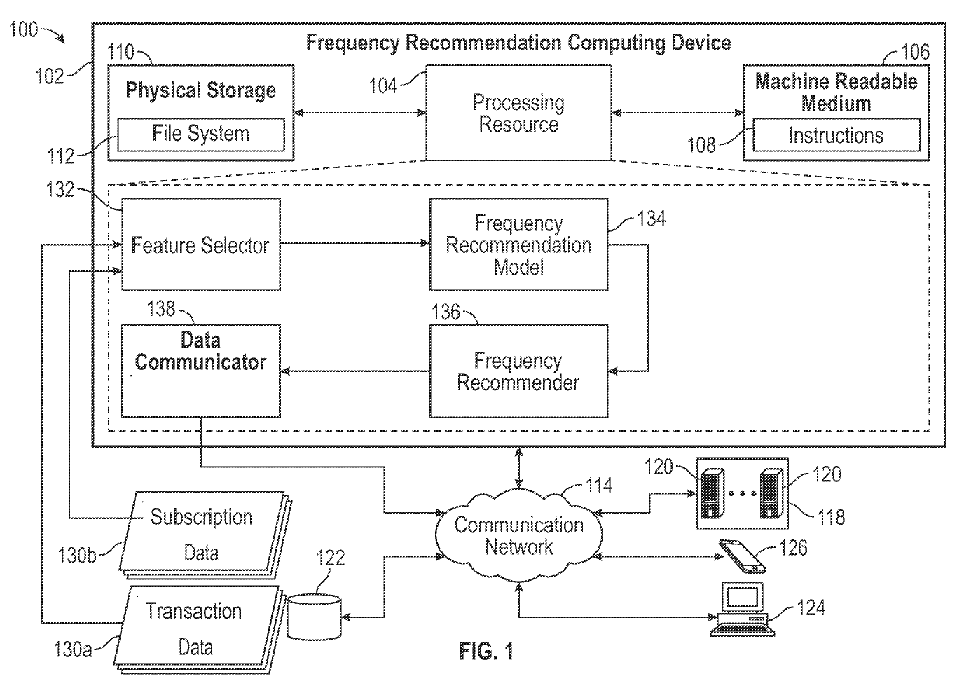

FIG. 1 depicts an example system 100 that recommends an inter-purchase interval (IPI) and/or a frequency of a subscription item, in accordance with some embodiments. The system 100 includes a frequency recommendation computing device 102 that recommends a dynamic inter-purchase interval (IPI) and/or a frequency of a subscription item for a customer based on transaction data 130a and subscription data 130b. The frequency recommendation computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The frequency recommendation computing device 102 includes a non-transitory machine readable medium 106 that may include one or more of a random-access memory (RAM), read-only memory (ROM), electrically erasable programmable read-only memory (EEPROM), flash memory, hard disk, and/or any other suitable memory resource.

The processing resource 104 may execute instructions 108 (i.e., programming or software code) stored on machine readable medium 106 to perform functions of the frequency recommendation computing device 102, such as determining purchase intervals for user-item pairs, training a frequency recommendation model, determining an inter-purchase interval for an item, determining a recommended frequency value for the item, etc. The instructions 108 may include instructions for implementing one or more models. In some embodiments, and as will be described further herein below, the frequency recommendation computing device 102 may execute one or more models, processes, or algorithms, such as a machine learning model, deep learning model, statistical model, etc., (e.g., as implemented as machine readable instructions) to generate subscription item frequency recommendations.

The frequency recommendation computing device 102 may also include other hardware components, such as physical storage 110. Physical storage 110 may include any physical storage device, such as a hard disk drive, a solid state drive, or the like, or a plurality of such storage devices (e.g., an array of disks), and may be locally attached (i.e., installed) in the frequency recommendation computing device 102. In some implementations, physical storage 110 may be accessed as a block storage device.

In some cases, the frequency recommendation computing device 102 may also include a local file system 112 that may be implemented as a layer on top of the physical storage 110. For example, an operating system may be executing on the frequency recommendation computing device 102 (by virtue of the processing resource 104 executing certain instructions 108 related to the operating system) and the operating system may provide a file system 112 to store data on the physical storage 110.

The network 114 may include a plurality of devices or systems in communication with the frequency recommendation computing device 102 over one or more network channels, illustrated as a network cloud. For example, in various embodiments, the frequency recommendation computing device 102 may be in communication with a web server 116, a cloud-based engine 118 including one or more processing devices 120 that may be provisioned for use, a database 122, a workstation 124, and/or any other suitable system or device. The frequency recommendation computing device 102 may similarly be in communication, either directly or indirectly, with one or more user computing devices 126 operatively coupled over the network 114. The other computing systems may be similar to the frequency recommendation computing device 102, and may each include at least a processing resource and a machine readable medium.

In some embodiments, a user submits a query on a website hosted by the web server (not shown). The web server may send the query to the frequency recommendation computing device 102. Separately or in connection with the user query, the frequency recommendation computing device 102 can receive transaction data 130a and/or subscription data 130b. In response to receiving the user query and the transaction data 130a and/or the subscription data 130, the frequency recommendation computing device 102 may execute one or more processes to recommend a frequency of a subscription item based on the transaction data 130a and/or subscription data 130b and transmit the results including a recommended frequency value to the web server to be displayed. Alternatively, the query and subsequent results can be received and/or presented at workstations 124, cloud-based engines 118, user computing devices 126, etc.

In the depicted example, the feature selector 132 receives transaction data 130a and/or subscription data 130b and can select, manipulate, and/or transform the transaction data 130a and/or the subscription data 130b into features for use with the frequency recommendation model 134. In some embodiments, the feature selector 132 can calculate purchase intervals for user-item pairs for a time period. For example, the feature selector 132 can calculate purchase intervals for user-item pairs for a 13-month period. In some embodiments, the feature selector 132 can calculate purchase intervals for user-item pairs and incorporate purchase quantity information. The feature selector 132 can further select, manipulate, and/or transform user features, item features and/or item type features for use with the frequency recommendation model 134. In some embodiments, the feature selector 132 can further utilize contextual information such as survey data and/or customer subscription interaction data.

In some embodiments, the available features from the feature selector 132 can be utilized to train a neural network such as frequency recommendation model 134 to determine or predict click-through rate for recommendations. In some embodiments, the available features from the feature selector 132 can be utilized to train a frequency recommendation model 134 that utilizes factorization machines and/or deep learning, such as DeepFM. As described herein, the feature selector 132 can further capture and integrate user updates and feedback to enhance the frequency recommendation model 134.

In the depicted example, the transaction data 130a can be obtained over a rolling transaction history period. In some embodiments, the rolling transaction history period is thirteen (13) months. The transaction data 130a can include omnichannel transaction data, customer understanding data, basket understanding data, item understanding data, and customer preference data.

In some embodiments, customer understanding data can include historical transactions and customer data. Historical transactions data can include previous online transactions, previous in-store transactions, etc. Customer data can include total orders, order rate, order interval, average spend per transaction, average basket size, days since last purchase, affinities, etc.

In some embodiments, basket understanding data can include personalized data. Personalized data can include patterns across baskets, purchase frequency, purchase recency, personal inter-purchase interval, purchase quantity, and product type.

In some embodiments, item understanding data can include product attributes and global features. Product attributes can include product metadata, perishability/shelf-life, taxonomy, and product type. Global features include global inter-purchase interval, global purchase frequency, reorder rate, global purchase quantity, and repurchase data.

In some embodiments, customer preference data can include customer interaction data. Customer interaction data can include acceptance or rejection of recommended frequency.

In the depicted example, the subscription data 130b can include customer-item active data, cancellation data, skip data, and feedback data. In some embodiments, feedback data can include quantitative feedback, and/or qualitative feedback. Customer interaction data can include acceptance or rejection of recommended frequency. Quantitative data can include customer preferred frequency data and qualitative data include customer narratives in connection with skipping or cancellation of subscriptions. Feedback data can further include survey data.

In the depicted example, the frequency recommendation model 134 can generate inter-purchase intervals (or frequency prediction) for user-item pairs based on customer-item signals. The frequency recommendation model 134 can infer or predict inter-purchase intervals for (i) user-item pairs that include historical data and (ii) user-item pairs that do not include historical data.

In the depicted example, the frequency recommender 136 can provide personalized recommendations for subscription items. In some embodiments, the frequency recommender 136 can convert inter-purchase intervals into relevant time periods (e.g. days, weeks, months, etc.). In some embodiments, the frequency recommender 136 can provide dynamic recommendations based on other data or parameters.

The data communicator 138 receives the recommended frequency of a subscription item for a customer and transmits the recommended frequency of a subscription item for a customer to one or more computing devices. For example, the recommended frequency of a subscription item for a customer can be transmitted to a server, a cloud-based engine 118, a workstation 124, etc. In some embodiments, transmitting the recommended frequency of a subscription item for a customer includes causing computing devices to present one or more user interface elements for a recommended frequency of a subscription item for a customer.

In some embodiments, training data is generated for one or more models (e.g., machine learning models, deep learning models, statistical models, algorithms, etc.) based on the data and/or input features, etc. One or more models are trained based on corresponding training data. The trained models may be stored in a database, such as in the database 122 (or a cloud storage database).

The models, when executed by the frequency recommendation computing device 102, allow the frequency recommendation computing device 102 to determine a recommended frequency of a subscription item for a customer. For example, the frequency recommendation computing device 102 may obtain one or more models from the database 122. The frequency recommendation computing device 102 may then receive, transaction data 130a and/or subscription data 130b. In response to receiving the transaction data 130a and/or subscription data 130b, the frequency recommendation computing device 102 may execute one or more models to determine a recommended frequency of a subscription item for a customer.

In some embodiments, the frequency recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, the frequency recommendation computing device 102 may determine a recommended frequency of a subscription item for a customer.

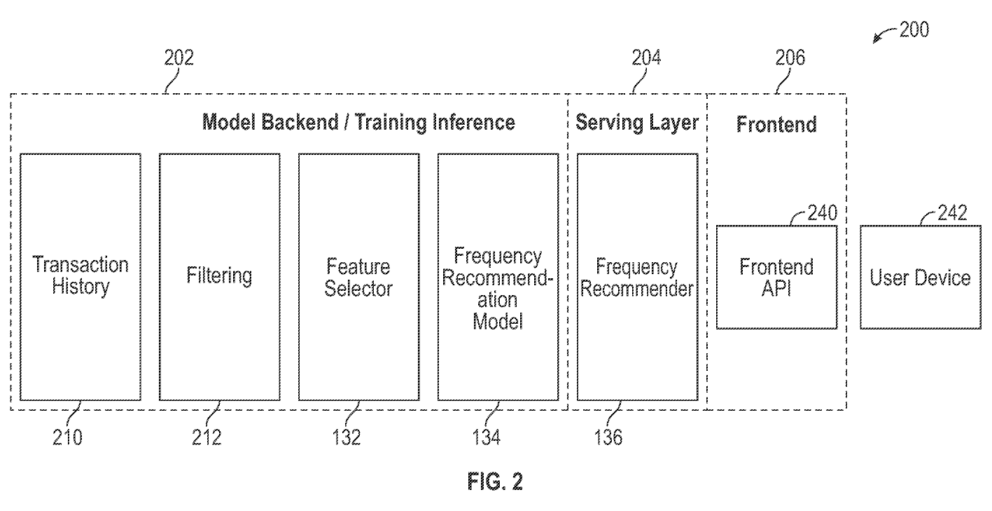

FIG. 2 depicts an example architecture 200 of a frequency recommendation system, in accordance with some embodiments. The system architecture 200 may be implemented by or with any suitable system or device, such as, for example, the frequency recommendation computing device 102 discussed above with respect to FIG. 1 (including, for example, the feature selector 132, frequency recommendation model 134, frequency recommender 136, as described below). The system architecture 200 may be implemented as part of the frequency recommendation process executed by the frequency recommendation computing device 102.

In some embodiments, transaction history 210 is stored in a training inference or model backend environment 202. As described herein, transaction history can include omnichannel transaction history. In some applications, the transaction history is over a rolling 13-month period. Further, filtering 212 can pre-process or filter the transaction history 210 for relevant features, such as product type, repurchase data, and subscription item filtering.

In the depicted example, the feature selector 132 obtains the filtered data and generates a set of features for use in model training, as discussed herein. In some embodiments, in addition to filtering 212, the feature selector 132 can audit the filtered data to identify or remove low-quality or irrelevant data. During operation, the feature selector 132 can calculate purchase intervals for user-item pairs for a time period. In some embodiments, the features obtained from the feature selector 132 are utilized to train the frequency recommendation model 134 within the model backend environment 202. The feature selector 132 can further select, manipulate, and/or transform user features, item features and/or item type features for use with the frequency recommendation model 134.

As described herein, the feature selector 132 can capture and integrate user updates and feedback to enhance the frequency recommendation model 134. In some embodiments, the feature selector 132 can integrate or utilize contextual information such as survey data and/or customer subscription interaction data. For example, the feature selector 132 may apply a known subscription frequency as a ground truth and as contextual data for the frequency recommendation model 134. In another example, the feature selector 132 may integrate survey responses regarding frequency recommendations into actionable groups (e.g. too frequent, too infrequent) as contextual categorical data for the frequency recommendation model 134.

In some embodiments, the frequency recommendation model 134 is deployed to a serving layer 204 via a frequency recommender 136 for deploying trained prediction models, such as the frequency recommendation model 134. In the depicted example, the frequency recommendation model 134 can generate inter-purchase intervals (or frequency prediction) for user-item pairs based on customer-item signals. The frequency recommendation model 134 can infer or predict inter-purchase intervals for (i) user-item pairs that include historical data and (ii) user-item pairs that do not include historical data. In the depicted example, the generated inter-purchase intervals can be provided to the serving layer 204 through the frequency recommender 136. In some embodiments, the frequency recommender 136 can capture and integrate user updates (e.g. current subscription frequency) and feedback to enhance the frequency recommendation model 134.

In the depicted example, a frontend API 240 can perform one or more interactions with a network system, such as interacting with the frequency recommender 136 in the serving layer 204. During operation, a user device 242 can interact with the frontend API 240 to request an interface. The frontend API 240 can serve an interface to the user device 242 that includes a recommendation or predicted frequency for a subscription item. The recommendation frequency can be dynamic and personalized to the customer based on the transaction history.

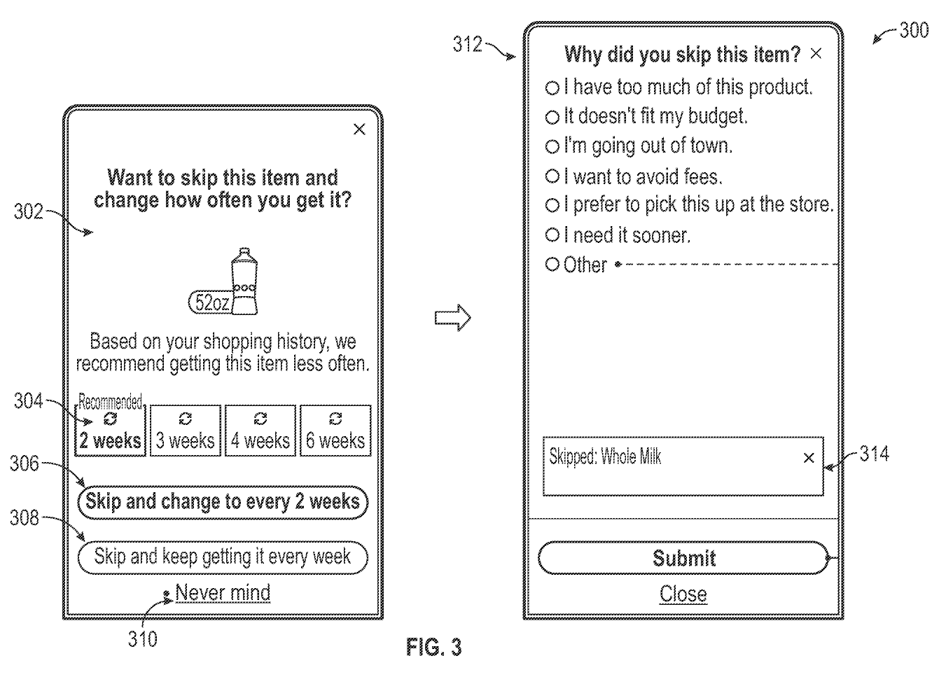

FIG. 3 depicts an example feedback interface 300 of a frequency recommendation system, in accordance with some embodiments. As described herein the frequency recommendation system can utilize customer interaction data for model enhancement. For example, the frequency recommendation model can utilize data regarding the acceptance or rejection of a recommended frequency for an item to enhance the frequency recommendation model. As described herein, quantitative feedback, such as a customer’s preferred item frequency, and qualitative feedback, such as reasons for skipping or canceling a subscription can be captured to enhance the frequency recommendation model.

For example, in response to customer requesting to skip a purchase of a subscription item 302, a frontend API can provide a skip feedback interface 300 to the user’s computing device to attempt to retain the subscription and collect feedback for the frequency recommendation model. In response to a skip request, the interface 300 can provide a dynamic frequency recommendation 304. As illustrated, a user can select an alternative subscription frequency, which can (i) be used to update the subscription information and (ii) be captured to enhance the frequency recommendation model as quantitative feedback. In the depicted example, the updated frequency can be either confirmed via button 306 or rejected (i.e. the original subscription frequency maintained) via button 308. A user may exit the interface 300 without skipping the subscription via link 310.

If a customer chooses to skip the current subscription interval, the customer can provide qualitative feedback via feedback form 312 to enhance the frequency recommendation model. In the depicted example, the customer can provide a reason for skipping the current subscription interval which can be captured for use by the frequency recommendation model. Further, the feedback form 312 can provide confirmation 314 of the skipped item.

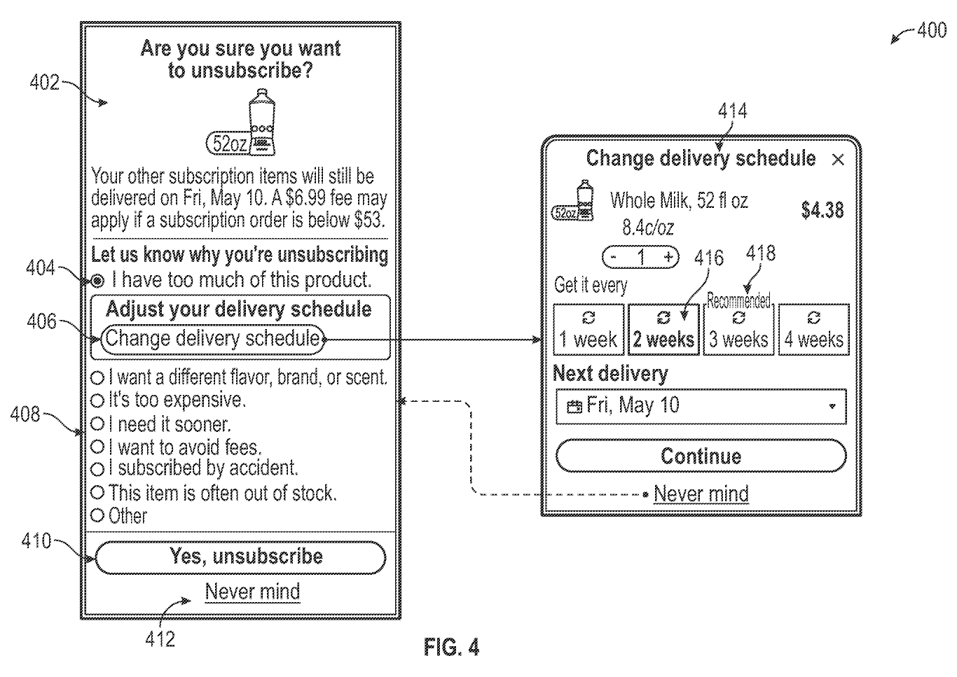

FIG. 4 depicts an example feedback interface 400 of a frequency recommendation system, in accordance with some embodiments. In another example, in response to customer requesting to cancel a subscription for item 402, a frontend API can provide a cancellation feedback interface 400 to the user’s computing device to attempt to retain the subscription and collect feedback for the frequency recommendation model. In response to a cancellation request, the customer can provide qualitative feedback via feedback form 408 to enhance the frequency recommendation model. In the depicted example, the customer can provide a reason for cancelling the current subscription interval which can be captured for use by the frequency recommendation model. Further, the feedback form 408 can provide confirmation of the cancelled item 402 via button 410. A user may exit the interface 400 without cancelling the subscription via link 412.

Further, if a customer provides feedback via the feedback form 408 indicating customer over-stock 404, the interface 400 can allow the customer to adjust the subscription frequency via button 406. In response to an over-stock 404 condition, the interface 400 can provide a dynamic frequency recommendation 418. As illustrated, a user can select an alternative subscription frequency 416, which can (i) be used to update the subscription information and (ii) be captured to enhance the frequency recommendation model as quantitative feedback. In the depicted example, the updated frequency can be either confirmed or rejected

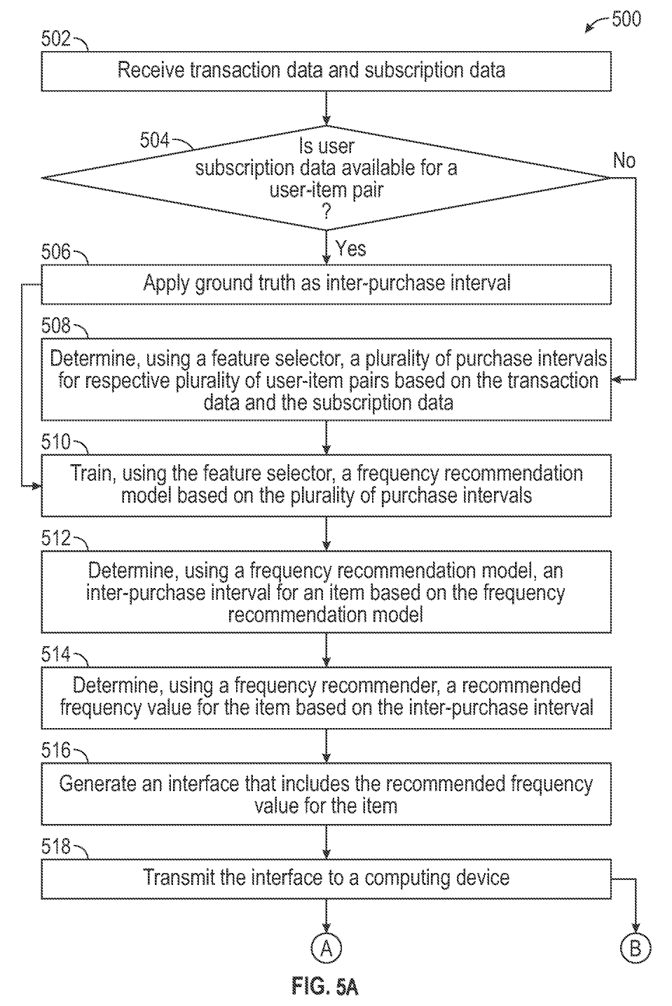

FIGS. 5-7 depict example methods for recommending a frequency of a subscription item for a customer, in accordance with some embodiments. In some embodiments, one or more blocks of the methods may be executed substantially concurrently and/or in a different order than shown. In some implementations, a method may include more or fewer blocks than are shown. In some implementations, one or more of the blocks of a method may, at certain times, be ongoing and/or may repeat. In some implementations, blocks of the method may be combined.

The methods shown in FIGS. 5-7 may be implemented in the form of executable instructions stored on machine-readable media and executed by a processing resource and/or in the form of electronic circuitry. For example, aspects of the methods may be described below as being performed by a frequency recommendation computing device 102, an example of which may be a feature selector 132, a frequency recommendation model 134, a frequency recommender 136, etc. running on a hardware processing resource 104 of the frequency recommendation computing device 102 described above in reference to FIG. 1. Additionally, other aspects of the methods described below may be described with reference to other elements shown in FIG. 1 for non-limiting illustration purposes.

FIGS. 5A and 5B depict a flow diagram for recommending a frequency for a subscription item, in accordance with some embodiments. The method 500 includes receiving (502) transaction data and subscription data. The method 500 includes determining (504) if user subscription data is available for a user-item pair. In accordance with a determination that user subscription data is not available for the user-item pair, the method 500 includes determining (508) using a feature selector, a plurality of purchase intervals for respective plurality of user-item pairs based on the transaction data and subscription data. In accordance with a determination that user subscription data is available for the user-item pair, the method 500 includes applying (506) the ground truth as the inter-purchase interval.

Additionally, the method 500 includes training (510), using the feature selector, a frequency recommendation model based on the plurality of purchase intervals. The method 500 further includes determining (512), using a frequency recommendation model, an inter-purchase interval for an item. The method 500 further includes determining (514), using a frequency recommender, a recommended frequency value for the item based on the inter-purchase interval. The method 500 further includes generating (516) an interface that includes the recommended frequency value for the item. The method 500 further includes transmitting (518) the interface to a computing device.

The method 500 includes determining (520) if the user intends to skip or cancel an item subscription. In accordance with a determination the user intends to skip or cancel an item subscription, the method 500 includes capturing (522) cancellation data or skip data for the item from the interface. The method further includes determining (524), using the feature selector, contextual cancellation categorical data or contextual skip categorical data based on the cancellation data or skip data. The method further includes training (526), using the feature selector, the frequency recommendation model based on the contextual cancellation categorical data or contextual skip categorical data. Alternatively, in accordance with a determination the user does not intend to skip or cancel an item subscription, the method 500 includes training (526), using the feature selector, the frequency recommendation model based on the contextual cancellation categorical data or contextual skip categorical data.

Further, the method 500 includes determining (528) if the user intends to change the inter-purchase interval or subscription frequency. In accordance with a determination the user intends to change the inter-purchase interval or subscription frequency, the method 500 includes capturing (530) updates to the recommended frequency value for the item from the interface as an inter-purchase interval ground truth. The method further includes determining (532), using the feature selector, inter-purchase interval ground truth features based on the inter-purchase interval ground truth. The method further includes training (534), using the feature selector, the frequency recommendation model based on the inter-purchase interval ground truth features. Alternatively, in accordance with a determination the user does not intend to change the inter-purchase interval or subscription frequency, the method 500 includes training (534), using the feature selector, the frequency recommendation model based on the inter-purchase interval ground truth features.

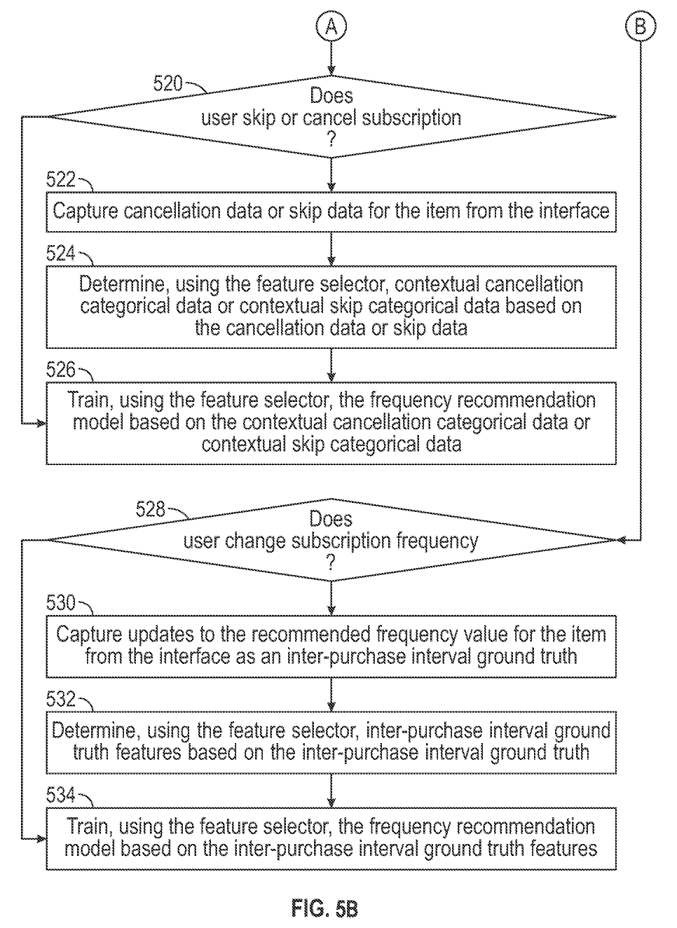

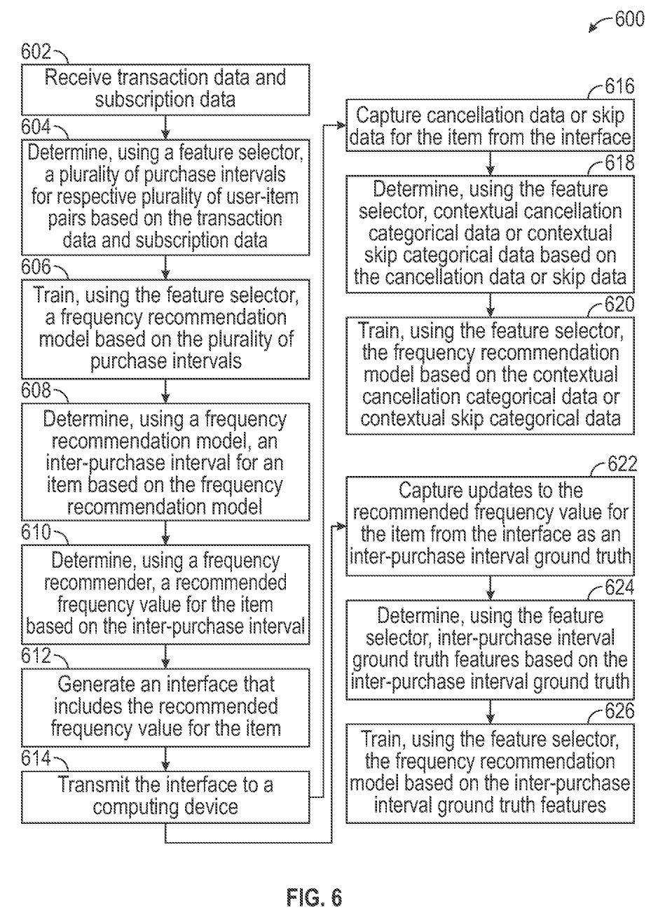

FIG. 6 depicts a flow diagram illustrating a method for recommending a frequency for a subscription item, in accordance with some embodiments. The method 600 starts at operation (602). At operation (602), the method 600 includes receiving transaction data and subscription data. The method 600 includes operation (604). Operation (604) includes determining, using a feature selector, a plurality of purchase intervals for respective plurality of user-item pairs based on the transaction data and the subscription data. The method 600 includes operation (606), which includes training, using the feature selector, a frequency recommendation model based on the plurality of purchase intervals. The method 600 also includes operation (608). Operation (608) includes determining, using a frequency recommendation model, an inter-purchase interval for an item. The method 600 includes operation (610), which includes determining, using a frequency recommender, a recommended frequency value for the item based on the inter-purchase interval. The method 600 further includes operation (612), which includes generating an interface that includes the recommended frequency value for the item. The method 600 further includes operation (614), which includes transmitting the interface to a computing device. In some embodiments, the method 600 ends at operation (614).

Optionally, the method 600 can include operation (616), which includes capturing cancellation data or skip data for the item from the interface. If the method 600 includes operation (616), the method 600 further includes operation (618) which includes determining, using the feature selector, contextual cancellation categorical data or contextual skip categorical data based on the cancellation data or skip data. If the method 600 includes operation (618), the method further includes operation (620), which includes training, using the feature selector, the frequency recommendation model based on the contextual cancellation categorical data or contextual skip categorical data. In some embodiments, the method 600 ends at operation (620).

Optionally, the method 600 can include operation (622), which includes capturing updates to the recommended frequency value for the item from the interface as an inter-purchase interval ground truth. If the method 600 includes operation (622), the method 600 further includes operation (624) which includes determining, using the feature selector, inter-purchase interval ground truth features based on the inter-purchase interval ground truth. If the method 600 includes operation (624), the method further includes operation (626), which includes training, using the feature selector, the frequency recommendation model based on the inter-purchase interval ground truth features. In some embodiments, the method 600 ends at operation (626).

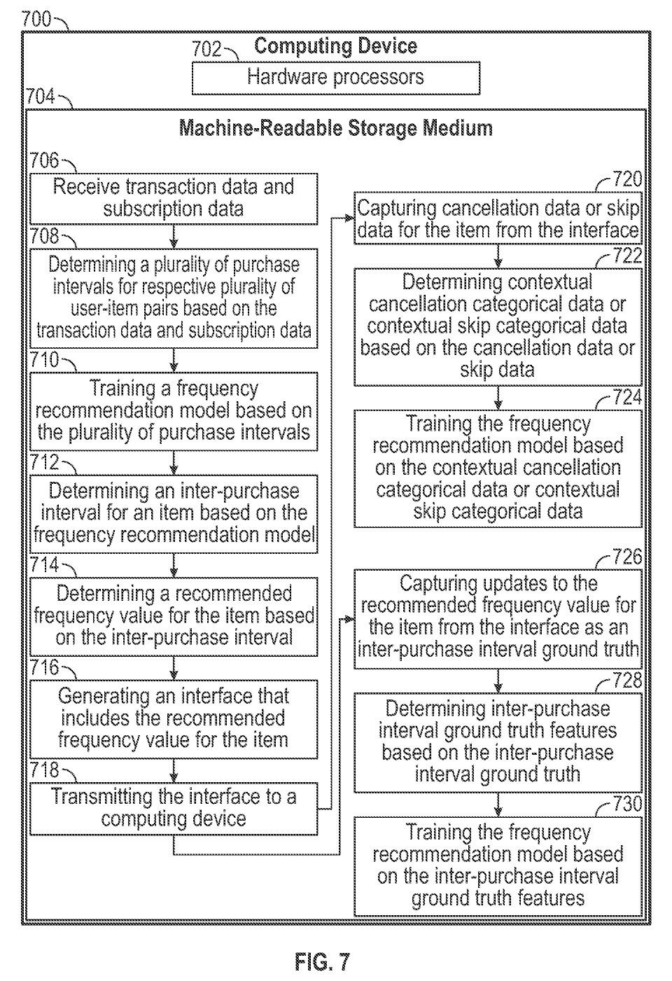

FIG. 7 depicts an example system 700 that includes non-transitory, machine-readable media 704 encoded with example instructions executable by processing resource 702. In some implementations, the system 700 may be useful for implementing aspects of the frequency recommendation computing device 102 of FIG. 1 and analogous systems. For example, the instructions encoded on machine-readable media 704 may be included in instructions 108 of FIG. 1. In some implementations, functionality described with respect to FIG. 1 may be included in the instructions encoded on machine-readable media 704.

The processing resource 702 may include a microcontroller, a microprocessor, central processing unit core(s), an ASIC, an FPGA, and/or other hardware device suitable for retrieval and/or execution of instructions from the machine-readable media 704 to perform functions related to various examples. Additionally, or alternatively, the processing resource 702 may include or be coupled to electronic circuitry or dedicated logic for performing some or all of the functionality of the instructions described herein.

The machine-readable media 704 may be any medium suitable for storing executable instructions, such as RAM, ROM, EEPROM, flash memory, a hard disk drive, an optical disc, or the like. In some example implementations, the machine-readable media 704 may be a tangible, non-transitory medium. The machine-readable media 704 may be disposed within the system 700 respectively, in which case the executable instructions may be deemed installed or embedded on the system. Alternatively, the machine-readable media 704 may be a portable (e.g., external) storage medium, and may be part of an installation package.

As described further herein below, the machine-readable media 704 may be encoded with a set of executable instructions. It should be understood that part or all of the executable instructions and/or electronic circuits included within one box may, in alternate implementations, be included in a different box shown in the figures or in a different box not shown. Some implementations may include more or fewer instructions than are shown in FIG. 7.

With reference to FIG. 7, the machine-readable media 704 includes instructions 706-730. Instructions 706, when executed, cause the processing resource 702 to receive transaction data and subscription data. Instructions 708, when executed, cause the processing resource 702 to determine a plurality of purchase intervals for respective plurality of user-item pairs based on the transaction data and the subscription data. Instructions 710, when executed, cause the processing resource 702 to train a frequency recommendation model based on the plurality of purchase intervals. Instructions 712, when executed, cause the processing resource 702 to determine an inter-purchase interval for an item based on the frequency recommendation model. Instructions 714, when executed, cause the processing resource 702 to determine a recommended frequency value for the item based on the inter-purchase interval. Instructions 716, when executed, cause the processing resource 702 to generate an interface that includes the recommended frequency value for the item. Instructions 718, when executed, cause the processing resource 702 to transmit the interface to a computing device.

Optionally, instructions 720, when executed, cause the processing resource 702 to capturing cancellation data or skip data for the item from the interface. Further optionally, instructions 722, when executed, cause the processing resource 702 to determining contextual cancellation categorical data or contextual skip categorical data based on the cancellation data or skip data. Further optionally, instructions 724, when executed, cause the processing resource 702 to training the frequency recommendation model based on the contextual cancellation categorical data or contextual skip categorical data.

In some embodiments, instructions 726, when executed, cause the processing resource 702 to capture updates to the recommended frequency value for the item from the interface as an inter-purchase interval ground truth. Further optionally, instructions 728, when executed, cause the processing resource 702 to determine inter-purchase interval ground truth features based on the inter-purchase interval ground truth. Further optionally, instructions 730, when executed, cause the processing resource 702 to train the frequency recommendation model based on the inter-purchase interval ground truth features.

In some embodiments, training data is generated for one or more models (e.g., machine learning models, deep learning models, statistical models, algorithms, etc.) based on historical data and features described above in reference to FIGS. 1 and 2. One or more models are trained based on corresponding training data. The trained models may be stored in a database, such as in a database (e.g., a cloud storage database).

The models, when executed by the frequency recommendation computing device 102, allow the frequency recommendation computing device 102 to recommend a frequency of a subscription item for a customer. For example, the frequency recommendation computing device 102, in response to receiving data may execute one or more models to determine a recommended frequency of a subscription item for a customer and generate an interface that includes the recommended frequency for the item.

In some embodiments, the frequency recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some embodiments, the virtual machines assign each model (or part thereof) among a plurality of processing units. Based on the output of the models, the frequency recommendation computing device 102 may generate an interface that includes the recommended frequency for the item.

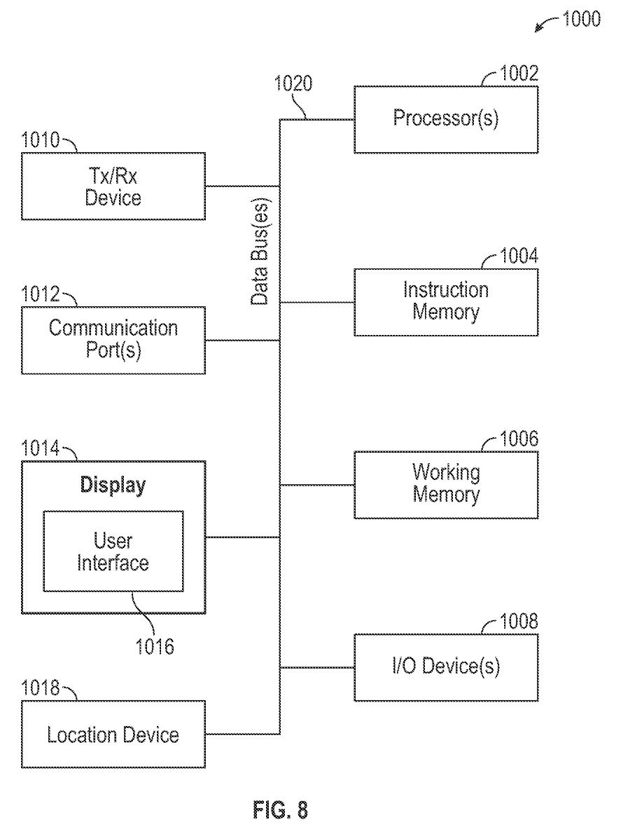

FIG. 8 illustrates a block diagram of a computing device 1000, in accordance with some embodiments. Although FIG. 8 is described with respect to certain components shown therein, it will be appreciated that the elements of the computing device 1000 may be combined, omitted, and/or replicated. In addition, it will be appreciated that additional elements other than those illustrated in FIG. 8 may be added to the computing device.

As shown in FIG. 8, the computing device 1000 may include one or more processing resources 1002, instruction memory 1004, working memory 1006, input/output devices 1008, transceiver 1010, communication ports 1012, display 1014, optional location device 1018, and/or any other suitable elements each operatively coupled to one or more data buses 1020. The data buses 1020 allow for communication among the various components. The data buses 1020 may include wired, or wireless, communication channels.

The one or more processing resources 1002 may include any processing circuitry operable to control operations of the computing device 1000. In some embodiments, the one or more processing resources 1002 include one or more distinct processors, each having one or more cores (e.g., processing circuits). Each of the distinct processors may have the same or different structure. The one or more processing resources 1002 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 1002 may also be implemented by a controller, a microcontroller, an application specific integrated circuit (ASIC), a field programmable gate array (FPGA), a programmable logic device (PLD), etc.

In some embodiments, the one or more processing resources 1002 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 1004 may store instructions that are accessed (e.g., read) and executed by at least one of the one or more processing resources 1002. For example, the instruction memory 1004 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 1002 may perform a certain function or operation by executing code, stored on the instruction memory 1004, embodying the function or operation. For example, the one or more processing resources 1002 may execute code stored in the instruction memory 1004 to perform one or more of any function, method, or operation disclosed herein.

Additionally, the one or more processing resources 1002 may store data to, and read data from, the working memory 1006. For example, the one or more processing resources 1002 may store a working set of instructions to the working memory 1006, such as instructions loaded from the instruction memory 1004. The one or more processing resources 1002 may also use the working memory 1006 to store dynamic data created during one or more operations. The working memory 1006 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 1004 and working memory 1006, it will be appreciated that the computing device 1000 may include a single memory unit that operates as both instruction memory and working memory. Further, although embodiments are discussed herein including non-volatile memory, it will be appreciated that computing device 1000 may include volatile memory components in addition to at least one non-volatile memory component.

In some embodiments, the instruction memory 1004 and/or the working memory 1006 includes an instruction set, in the form of a file for executing various methods, such as methods for determining a recommended frequency of a subscription item for a customer, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 1002.

The input/output devices 1008 may include any suitable device that allows for data input or output. For example, the input/output devices 1008 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 1010 and/or the communication port(s) 1012 allow for communication with a network. For example, if a communication network is a cellular network, the transceiver 1010 allows communications with the cellular network. In some embodiments, the transceiver 1010 is selected based on the type of the communication network the computing device 1000 will be operating in. The one or more processing resources 1002 are operable to receive data from, or send data to, a network, via the transceiver 1010.

The communication port(s) 1012 may include any suitable hardware, software, and/or combination of hardware and software that is capable of coupling the computing device 1000 to one or more networks and/or additional devices. The communication port(s) 1012 may be arranged to operate with any suitable technique for controlling information signals using a desired set of communications protocols, services, or operating procedures. The communication port(s) 1012 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 1012 allows for the programming of executable instructions in the instruction memory 1004. In some embodiments, the communication port(s) 1012 allow for the transfer (e.g., uploading or downloading) of data, such as machine learning model training data.

In some embodiments, the communication port(s) 1012 couples the computing device 1000 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 1010 and/or the communication port(s) 1012 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1xRTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 1014 may be any suitable display, and may display the user interface 1016. The user interfaces 1016 may enable user interaction with a frequency recommendation system. For example, the user interface 1016 may be a user interface for an application of a network environment operator that allows a user to view and interact with the operator’s website. In some embodiments, a user may interact with the user interface 1016 by engaging the input/output devices 1008. In some embodiments, the display 1014 may be a touchscreen, where the user interface 1016 is displayed on the touchscreen.

The display 1014 may include a screen such as, for example, a Liquid Crystal Display (LCD) screen, a light-emitting diode (LED) screen, an organic LED (OLED) screen, a movable display, a projection, etc. In some embodiments, the display 1014 may include a coder/decoder, also known as Codecs, to convert digital media data into analog signals. For example, the visual peripheral output device may include video Codecs, audio Codecs, or any other suitable type of Codec.

The optional location device 1018 may be communicatively coupled to a location network and operable to receive position data from the location network. For example, in some embodiments, the location device 1018 includes a GPS device that receives position data identifying a latitude and longitude from one or more satellites of a GPS constellation. As another example, in some embodiments, the location device 1018 is a cellular device that receives location data from one or more localized cellular towers. Based on the position data, the computing device 1000 may determine a local geographical area (e.g., town, city, state, etc.) of its position.

In some embodiments, the computing device 1000 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular example implementation herein, unless such limitations are expressly called out. In addition, a module/engine may itself be composed of more than one sub- modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 1000 may be a computer, a workstation, a laptop, a server such as a cloud-based server, or any other suitable device. In some embodiments, the computing device 1000 is a server that includes one or more processing units, such as one or more graphical processing units (GPUs), one or more central processing units (CPUs), and/or one or more processing cores. The computing device 1000 may, in some embodiments, execute one or more virtual machines. In some embodiments, processing resources (e.g., capabilities) of the computing device 1000 are offered as a cloud-based service (e.g., cloud computing).

Although embodiments are illustrated herein including certain systems and/or devices, it will be appreciated that additional systems, servers, storage mechanism, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Training models based on training data the trained function is able to adapt to new circumstances and to detect and extrapolate patterns. In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

It will be appreciated that frequency recommendations determined by the frequency recommendation computing device 102 based on user data as disclosed herein, particularly on large datasets intended to be used with feature selector 132, a frequency recommendation model 134, and/or a frequency recommender 136 (or other components of the frequency recommendation computing device 102), are only possible with the aid of computer-assisted machine-learning algorithms and techniques. In some embodiments, machine learning processes are used to perform operations that cannot practically be performed by a human, either mentally or with assistance. It will be appreciated that a variety of machine learning techniques can be used alone or in combination to determine a recommended frequency of a subscription item for a customer, etc.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive subscription data and transaction data;
determine, using a feature selector, a plurality of purchase intervals for respective plurality of user-item pairs based on the subscription data and the transaction data;
train, using the feature selector, a frequency recommendation model based on the plurality of purchase intervals;
determine, using a frequency recommendation model, an inter-purchase interval for an item;
determine, using a frequency recommender, a recommended frequency value for the item based on the inter-purchase interval;
generate an interface that includes the recommended frequency value for the item; and
transmit the interface to a computing device.

2. The system of claim 1, wherein the transaction data includes one or more of: customer understanding data; item understanding data; customer preference data; and basket understanding data.

3. The system of claim 1, wherein the subscription data includes survey data.

4. The system of claim 1, wherein the subscription data includes one or more of a customer preferred frequency, cancellation data, and skip data.

5. The system of claim 1, wherein the instructions, when executed, further cause the processor to capture updates to the recommended frequency value for the item from the interface as an inter-purchase interval ground truth.

6. The system of claim 5, wherein the instructions, when executed, further cause the processor to determine, using the feature selector, inter-purchase interval ground truth features based on the inter-purchase interval ground truth.

7. The system of claim 6, wherein the instructions, when executed, further cause the processor to train, using the feature selector, the frequency recommendation model based on the inter-purchase interval ground truth features.

8. The system of claim 1, wherein the instructions, when executed, further cause the processor to capture cancellation data or skip data for the item from the interface.

9. The system of claim 8, wherein the instructions, when executed, further cause the processor to determine, using the feature selector, contextual cancellation categorical data or contextual skip categorical data based on the cancellation data or skip data.

10. The system of claim 9, wherein the instructions, when executed, further cause the processor to train, using the feature selector, the frequency recommendation model based on the contextual cancellation categorical data or contextual skip categorical data.

11. A computer-implemented method, comprising:
receiving subscription data and transaction data;
determining a plurality of purchase intervals for respective plurality of user-item pairs based on the subscription data and the transaction data;
training a frequency recommendation model based on the plurality of purchase intervals;
determining an inter-purchase interval for an item based on the frequency recommendation model;
determining a recommended frequency value for the item based on the inter-purchase interval;
generating an interface that includes the recommended frequency value for the item; and
transmitting the interface to a computing device.

12. The computer-implemented method of claim 11, wherein the transaction data includes one or more of: customer understanding data; item understanding data; customer preference data; and basket understanding data.

13. The computer-implemented method of claim 11, wherein the subscription data includes one or more of a customer preferred frequency, cancellation data, and skip data.

14. The computer-implemented method of claim 11, further comprising:
capturing updates to the recommended frequency value for the item from the interface as an inter-purchase interval ground truth;
determining inter-purchase interval ground truth features based on the inter-purchase interval ground truth; and
training the frequency recommendation model based on the inter-purchase interval ground truth features.

15. The computer-implemented method of claim 11, further comprising:
capturing cancellation data or skip data for the item from the interface;
determining contextual cancellation categorical data or contextual skip categorical data based on the cancellation data or skip data; and
training the frequency recommendation model based on the contextual cancellation categorical data or contextual skip categorical data.

16. A non-transitory computer readable medium having instructions stored thereon, wherein the instructions, when executed by at least one processor, cause at least one device to perform operations comprising:
receiving subscription data and transaction data;
determining, using a feature selector, a plurality of purchase intervals for respective plurality of user-item pairs based on the subscription data and the transaction data;
training, using the feature selector, a frequency recommendation model based on the plurality of purchase intervals;
determining, using a frequency recommendation model, an inter-purchase interval for an item;
determining, using a frequency recommender, a recommended frequency value for the item based on the inter-purchase interval;
generating an interface that includes the recommended frequency value for the item; and
transmitting the interface to a computing device.

17. The non-transitory computer readable medium of claim 16, wherein the transaction data includes one or more of: customer understanding data; item understanding data; customer preference data; and basket understanding data.

18. The non-transitory computer readable medium of claim 16, wherein the subscription data includes one or more of a customer preferred frequency, cancellation data, and skip data.

19. The non-transitory computer readable medium of claim 16, wherein the instructions, when executed by the at least one processor, cause the at least one device to perform operations further comprising:
capturing updates to the recommended frequency value for the item from the interface as an inter-purchase interval ground truth;
determining, using the feature selector, inter-purchase interval ground truth features based on the inter-purchase interval ground truth; and
training, using the feature selector, the frequency recommendation model based on the inter-purchase interval ground truth features.

20. The non-transitory computer readable medium of claim 16, wherein the instructions, when executed by the at least one processor, cause the at least one device to perform operations further comprising:
capturing cancellation data or skip data for the item from the interface;
determining, using the feature selector, contextual cancellation categorical data or contextual skip categorical data based on the cancellation data or skip data; and
training, using the feature selector, the frequency recommendation model based on the contextual cancellation categorical data or contextual skip categorical data.
